(19) United States
(12) Patent Application Publication
(10) Pub. No.: US 2015/0130299 A1
(43) Pub. Date: May 14, 2015

(54) ROTATING ELECTRIC MACHINE

(71) Applicant: KABUSHIKI KAISHA YASKAWA DENKI, Kitakyushu-shi (JP)

(72) Inventors: Sohei OGA, Kitakyushu-shi (JP); Tuyoshi NONAKA, Kitakyushu-shi (JP)

(73) Assignee: KABUSHIKI KAISHA YASKAWA DENKI, Kitakyushu-shi (JP)

(21) Appl. No.: 14/603,359

(22) Filed: Jan. 23, 2015

Related U.S. Application Data
(63) Continuation of application No. PCT/JP2012/068880, filed on Jul. 25, 2012.

(51) Int. Cl. H02K 3/38; H02K 3/30; H02K 3/28

(52) U.S. Cl. CPC H02K 3/38; H02K 3/28; H02K 3/30
USPC 310/43; 310/71

(57) ABSTRACT

This disclosure discloses a rotating electric machine includes a rotor disposed rotatably, a stator including a plurality of stator windings, and a connector unit connecting ends of the plurality of stator windings. The connector unit includes a plurality of conductors, and a plurality of resin films each formed sterically to insulate the plurality of conductors from one another.

### CROSS-REFERENCE TO RELATED APPLICATION

This is a continuation application PCT/JP2012/068880, filed Jul. 25, 2012, which was published under PCT article 21(2) in English.

### TECHNICAL FIELD

The disclosure relates to a rotating electric machine.

### BACKGROUND

An insulating housing for AC three-phase motor is known. The insulating housing houses a terminal (conductor) and an insulating plate alternately arranged in a ring-shaped housing groove formed in an upper surface of the housing, and fixes the terminal to a bearer disposed in the housing by caulking.

### SUMMARY

According to one aspect of the disclosure, there is provided a rotating electric machine includes a rotor disposed rotatably, a stator including a plurality of stator windings, and a connector unit connecting ends of the plurality of stator windings. The connector unit includes a plurality of conductors, and a plurality of resin films each formed sterically to insulate the plurality of conductors from one another.

### BRIEF DESCRIPTION OF THE DRAWINGS

FIG. 1 is an axial sectional view of a rotating electric machine according to an embodiment.

FIG. 2 is an explanatory view conceptually illustrating a relationship between a connector unit and a stator winding.

FIG. 3 is an explanatory view illustrating a relationship between a connector unit and a stator winding in a comparative example.

FIG. 4 is a perspective view illustrating an outline of the connector unit for the stator winding.

FIG. 5 is an exploded perspective view of the connector unit.

FIG. 6 is a connection diagram of the stator windings.

FIG. 7 is a sectional view of a resin film used for the connector unit.

FIG. 8 is a sectional view of a plane W in an axial direction seen from an arrow R direction in FIG. 5.

FIG. 9 is a sectional view of the connector unit in the comparative example.

### DESCRIPTION OF THE EMBODIMENTS

An embodiment will be described below referring to the drawings.

### <Structure of Rotating Electric Machine>

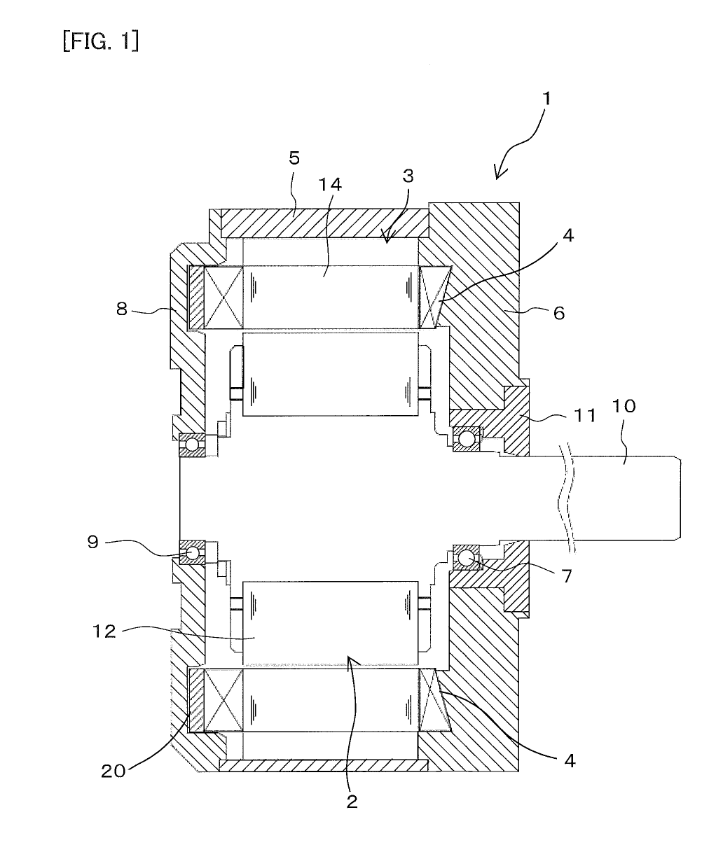

As FIG. 1 illustrates, a rotating electric machine 1 according to the present embodiment includes a substantially cylindrical stator 3 as an armature, a rotor 2 which is rotatably supported as a field system, a cylindrical frame 5, a load-side bracket 6, a load-side bearing 7, an opposite load-side bracket 8, an opposite load-side bearing 9, and a shaft 10. The rotating electric machine 1 is a synchronous motor with embedded magnet, which includes the rotor 2 inside the stator 3.

The shaft 10 is rotatably supported with the load-side bearing 7 and the opposite load-side bearing 9. The load-side bearing 7 has an outer ring fitted with the load-side bracket 6. The opposite load-side bearing 9 has an outer ring fitted with the opposite load-side bracket 8.

The frame 5 is disposed on an outer circumferential side of the stator 3. The load-side bracket 6 is disposed on the load side (right side in FIG. 1) of the frame 5. The opposite load-side bracket 8 is disposed on the opposite load-side (left side in FIG. 1) of the frame 5. The load-side bracket 6 and the opposite load-side bracket 8 are secured to the frame 5 with not shown bolts. The load-side bracket 6 has a dust seal 11 disposed outside the load-side bearing 7 for the purpose of preventing intrusion of foreign matters to the inside of the stator 3.

The rotor 2 includes an annular rotor iron core 12 and a plurality of not shown permanent magnets axially embedded in the rotor iron core 12. The rotor 2 has an embedded magnet structure with a plurality of poles, in which the radial outer sides of the adjacent permanent magnets function as magnetic poles.

The stator 3 is disposed to surround the outer circumferential side of the rotor 2 in the radial direction with a magnetic air gap therebetween. The stator 3 has an annular stator iron core 14 and stator windings 4.

The stator iron core 14 is disposed on an inner peripheral surface of the frame 5, and has a plurality of not shown slots in the peripheral direction. The stator windings 4 are housed in a plurality of slots, respectively.

A connector unit 20 electrically connected with the respective ends of the stator windings 4 is arranged on an end surface of the stator iron core 14 at the opposite load-side. The connector unit 20 is connected to an external power source via a not shown lead wire so that power is supplied to the stator windings 4 from the external power source via the connector unit 20.

### <Example of Stator Winding 4>

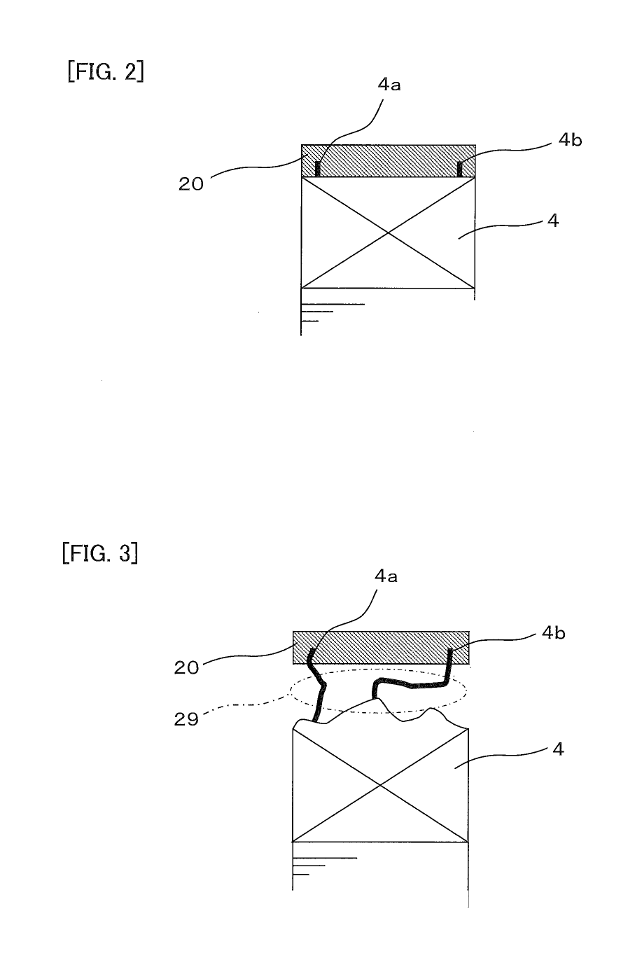

In this embodiment, the stator winding 4 is produced by winding a round copper wire around a jig, pressure-molding an outer shape, and heat-fusing it. The round copper wire for the stator winding 4 is wound at the position as determined so that a winding-beginning end 4a and a winding-finishing end 4b are positioned at predetermined positions. The winding of the round copper wire is conducted to realize the complete alignment winding in the range other than the opposite load-side coil end, and intersections are all made at the opposite load-side coil end. As a result, as shown in FIG. 2, it is possible to arrange the stator winding 4 and the connector unit 20 without leaving the gap therebetween so that the winding-beginning end 4a and the winding-finishing end 4b of the stator winding 4 are connected to the connector unit 20 (specifically, a winding connector 22 to be described later).

FIG. 3 illustrates the case where the outer shape of the stator winding 4 is not formed, and positions of the winding-beginning end 4a and the winding-finishing end 4b are not fixed. Referring to FIG. 3, in this case, larger space 29 for leading the winding-beginning end 4a and the winding-finishing end 4b to the connector unit 20 is required compared with the case shown in FIG. 2. As a result, the size of the rotating electric machine 1 is enlarged.

### <Connection Part>

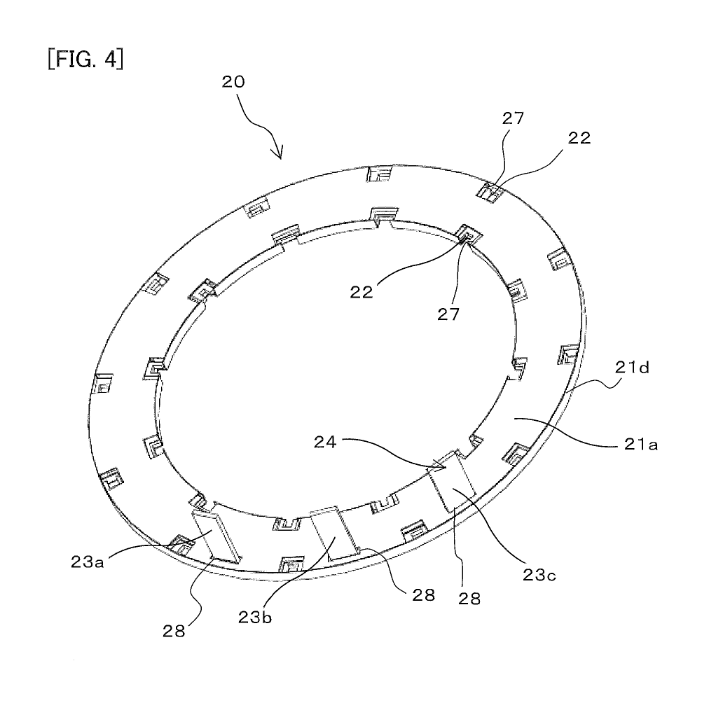

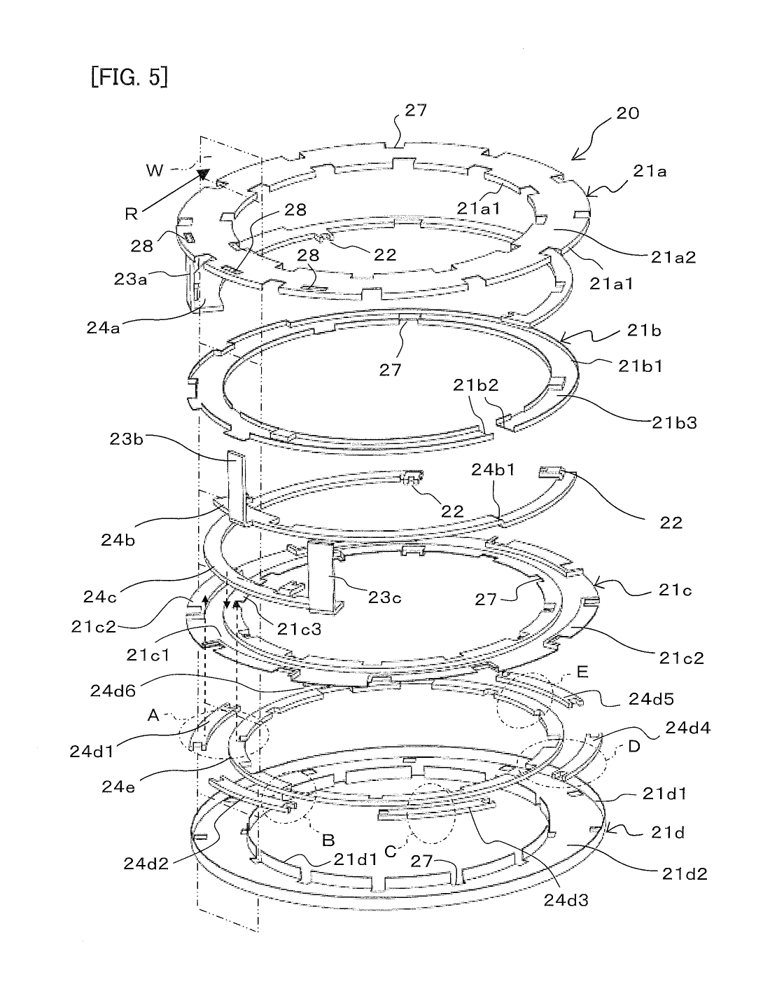

The detail structure of the connector unit 20 will be described referring to FIGS. 4 to 8. As FIGS. 4 and 5 show, the connector unit 20 has conductors 24a, 24b, 24c, 24d, 24e each produced by punching and folding the copper plate, for example, into a bent shape, and sterically formed resin films 21a, 21b, 21c, 21d.

The conductors 24a, 24b, 24c, 24d, 24e are laminated substantially in this order from one axial side (upper side in FIG. 5) to the other axial side (lower side in FIG. 5) of the rotor 2. Likewise, the resin films 21a, 21b, 21c, 21d are laminated substantially in this order from one axial side to the other axial side of the rotor 2. The conductors 24a-24e, and the resin films 21a-21d as a whole are, as shown in FIG. 5, laminated from one axial side to the other axial side of the rotor 2 in the order of the resin film 21a, the conductor 24a, the resin film 21b, the conductor 24b, the conductor 24c, the resin film 21c, the conductors 24d, 24e, and the resin film 21d.

### <Specific Structure of Conductor>

The conductor 24a is formed into a partially arc-like shape having approximately ⅓ of the arc (whole circumference corresponding to the central angle 360° of the circle) cut. A cable connector 23a is erected at an end of one circumferential side of the conductor 24a (counterclockwise direction side) toward one axial side (upward in FIG. 5).

The conductor 24b is formed into a partially arc-like shape with substantially the same diameter as that of the conductor 24a, having approximately more than half the arc notched. A stepped part 24b1 is formed on a part of the conductor 24b in the circumferential direction. The conductor 24b is arranged so that the open part of the arc (missing part of the arc) substantially faces the open part of the conductor 24a. A cable connector 23b is erected, similar to the above conductor 24a, at the point near the end at the other circumferential side of the conductor 24b (clockwise direction side) toward one axial side (upward in FIG. 5). The cable connector 23b of the conductor 24b is located slightly shifted from the position of the cable connector 23a of the conductor 24a to one circumferential side.

The conductor 24c has substantially the same diameter as each diameter of the conductors 24a and 24b, having a partially arc-like shape with more than half the arc notched. The conductor 24c is arranged so that the open part of the arc is turned by 1/3 toward the other circumferential side with respect to the open part of the conductor 24b. Likewise the conductors 24a, 24b, a cable connector 23c is erected at the end of the conductor 24c at one circumferential side toward one axial side (upward in FIG. 5). The cable connector 23c of the conductor 24c is arranged so as to be further shifted slightly from the cable connector 23b of the conductor 24b toward the one circumferential side.

The conductor 24d includes a plurality of (six in this embodiment) fragmental arc pieces 24d1, 24d2, 24d3, 24d4, 24d5, 24d6 along the circumferential direction. The arc pieces 24d1-24d6 constitute the conductor 24d with a larger diameter compared with the conductors 24a, 24b, 24c.

The conductor 24e with a smaller diameter as that of the conductor 24d is formed to have an annular shape with no notched part.

### <Specific Resin Film Structure>

The resin film 21a has a steric structure including collars 21a1 and a flat plate part 21a2, which are integrally formed. The flat plate part 21a2 with substantially the same diameter as that of the conductor 24a has substantially an annular plate-like shape. The collars 21a1 are erected at inner and outer circumferential sides of the flat plate part 21a2 along the axial direction (vertical direction in FIG. 5) downward in FIG. 5.

The resin film 21b has a steric structure including collars 21b1 and a flat plate part 21b3, which are integrally formed. The flat plate part 21b3 with substantially the same diameter as that of the flat plate part 21a2 of the resin film 21a has substantially an annular plate-like shape. The flat plate part 21b3 has a part of the substantially annular shape notched in the circumferential direction so that open ends 21b2, 21b2 face with each other, interposing the notched part (opening) along the circumferential direction. The collars 21b1 are erected at inner and outer circumferential sides of the flat plate part 21b3 along the axial direction (vertical direction in FIG. 5) upward in FIG. 5.

The resin film 21c has a steric structure including a flat plate part 21c1 and visors 21c2, 21c3, which are integrally formed. The flat plate part 21c1 has substantially an annular plate-like shape with a diameter smaller than that of the flat plate part 21a2 of the resin film 21a, and larger than that of the flat plate part 21b3 of the resin film 21b. The visors 21c2 are intermittently disposed on the radial outer side of the flat plate part 21c1 along the circumferential direction. The visors 21c3 are continuously disposed on the radial inner side of the flat plate part 21c1 along the circumferential direction.

The resin film 21d has a steric structure including collars 21d1 and a flat plate part 21d2, which are integrally formed. The flat plate part 21d2 has substantially an annular plate-like shape with a diameter larger than that of the resin film 21a. The collars 21d1 are erected on the inner and outer circumferential sides of the flat plate part 21d2 along the axial direction (vertical direction in FIG. 5) upward in FIG. 5.

### <Lamination Form of Conductor and Resin Film>

The connector unit 20 is formed by axially laminating the resin films 21 (21a, 21b, 21c, 21d) and the conductors 24 (24a, 24b, 24c, 24d, 24e) in a predetermined order, which are integrally adhered to one another.

As FIG. 5 illustrates, the conductors 24d and 24e are accommodated in radial outer and inner sides of the recess region surrounded by the collars 21d1, 21d1, and the flat plate part 21d2 of the resin film 21d. Subsequently, the resin film 21c is laminated on those conductors 24d and 24e. At this time, the conductor 24d is in contact with the back surface of the visor 21c2 at the radial outer side of the resin film 21c. In other words, the conductor 24d is accommodated in the recess region (corresponding to an example of a second recess region) of the back surface of the visor 21c2. The conductor 24e is in contact with the back surface of the visor 21c3 at the radial inner side of the resin film 21c. In other words, the conductor 24e is accommodated in the recess region (corresponding to an example of a second recess region) of the back surface of the visor 21c3.

The conductor 24c is laminated and accommodated in the recess region (corresponding to an example of a first recess region) surrounded by the visors 21c2, 21c3 and the flat plate part 21c1 of the resin film 21c.

Subsequently, the stepped part 24b1 of the conductor 24b is passed through an opening 21b2 of the resin film 21b so that the conductor 24b at the side of the cable connector 23b (left side in FIG. 5) is exposed upward of the resin film 21b in FIG. 5. The side of the conductor 24b, which faces the cable connector 23b (right side in FIG. 5) is brought to the position below the resin film 21b shown in FIG. 5. As a result, the part of the conductor 24b, which faces the cable connector 23b (right side in FIG. 5) is accommodated in the recess region surrounded by the visors 21c2, 21c3, and the flat plate part 21c1 of the resin film 21c likewise the conductor 24c as described above. Meanwhile, the part of the conductor 24b at the side of the cable connector 23b (left side in FIG. 5) is accommodated in the recess region surrounded by the collars 21b1, 21b1, and the flat plate part 21b3 of the resin film 21b.

The conductor 24a is accommodated in the part as the rest of the recess region of the resin film 21b (the part where the conductor 24b is not accommodated).

Subsequently, lamination of the resin film 21a on the conductor 24a provides the laminated body of the conductors 24a-24e and the resin films 21a-21d in the state where the collars 21d1, 21d1 at the inner and the outer circumferential sides of the resin film 21d enclose the collars 21a1, 21a1 at the inner and the outer circumferential sides of the resin film 21a.

The conductors 24 and the resin films 21 are laminated and adhered through adhesion using appropriate adhesive, by which the thin substantially ring-shaped connector unit 20 shown in FIG. 4 is assembled. The connector unit 20 is arranged close to the above-described plurality of stator windings 4 which is arranged in the cylindrical shape. In the above-described manner, a major part of the surface of the connector unit 20 is covered with the resin film 21 to ensure reliable insulation from the other adjacent components in the rotating electric machine 1.

In the above state, the conductors such as the conductors 24a, 24b, 24c include winding connectors 22 for connection to each end of the stator windings 4, respectively. Winding connection openings 27 are formed in a plurality of points at the inner and the outer circumferential sides of the corresponding resin films 21a, 21b, 21c, 21d of the connector unit 20 with the laminated structure (in this example, 12 points in total) so that the winding connectors 22 are exposed without being covered.

The cable connectors 23a, 23b, 23c are arranged on the surface of the connector unit 20, protruding therefrom at one axial side (upper side in FIG. 4) so as to connect the three-phase power supply cable. The respective cable connectors 23a-23c appear outside the connector unit 20 from the inside via cable connection openings 28 formed in the corresponding positions of the resin films 21a-21d (resin film 21a is only shown).

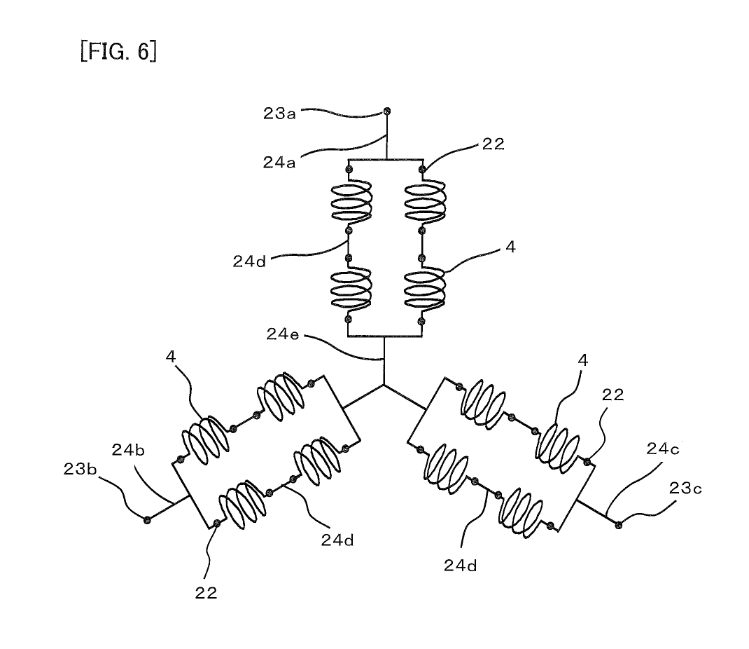

The stator windings 4 are connected via the winding connector 22 and the cable connectors 23a-23c as shown in FIG. 6, for example. Referring to the example, in the rotating electric machine 1, 12 stator windings 4 are disposed. Four stator windings 4 are serial-parallel connected to form the single phase. The 12 stator windings 4 are connected to form the three-phase star-like shape. The connection of each phase uses the conductors 24a, 24b, 24c, 24d, 24e of the above-described connector unit 20. Those conductors 24a-24d connect the stator windings 4 to the cable connectors 23a, 23b, 23c, respectively.

The winding connector 22 and the cable connectors 23a-23c correspond to an example of a connector described in the respective claims, and the winding connection openings 27 and the cable connection openings 28 correspond to an example of an opening described in the respective claims.

The resin films 21a, 21b, 21c, 21d correspond to an example of means for insulating conductors arranged adjacently to each other along a radial direction of the rotor and conductors arranged adjacently to each other along an axial direction of the rotor from one another using a resin film described in claims.

### <Specific Resin Film Structure>

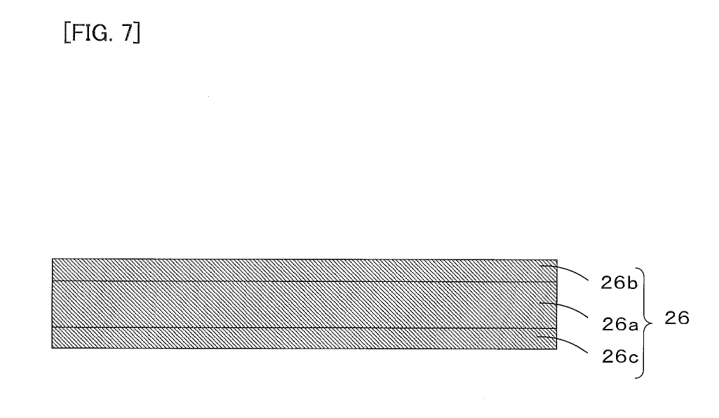

Each of the resin films 21a, 21b, 21c, 21d is formed by sterically molding a three-layer laminated film 26 as shown in FIG. 7. Specifically, each of the resin films 21a-21d is sterically molded into a desired shape by heat-molding the laminated film 26 between the male mold and the female mold.

The laminated film 26 includes a film body 26a, a woven fabric 26b laminated on one side (upper side in FIG. 7) of the film body 26a, and a woven fabric 26c laminated on the other side (lower side in FIG. 7) of the film body 26a. The laminated film 26 is formed as an integrated single sheet by heating and fusing the woven fabric 26b, the film body 26a, and the woven fabric 26c which have been laminated. The laminated film 26 may be manufactured at the low cost compared with the resin film formed through the extrusion molding of the thermoplastic resin, thus reducing the material cost. Consideration is given to the part of the resin film 21 for insulating the conductor 24 so that the holes and the missing parts are not formed in the film body 26a in processing the laminated film 26.

In this case, the film body 26a is made of the thermoplastic resin material, for example, PPS (polyphenylene sulfide). However, it is possible to use, for the film body 26a, an appropriate resin material in accordance with heat resistance required for the resin film 21. If the heat resistance required for the resin film 21 is low, it is possible to use PEN (polyethylenenaphthalate) for forming the film body 26a.

If the film body 26a is only used for forming the resin film 21 without using the woven fabric layer, the adhesive is insufficient for adhesion, resulting in difficulties in adhesion to the conductors 24 and other structures of the rotating electric machine 1. In this embodiment, two layers of woven fabrics 26b, 26c are added to the film body 26a so as to improve the adhesiveness of the resin film 21 to the conductors 24 and any other structures of the rotating electric machine 1, ensuring easy and reliable integration. It is preferable to use the adhesive with excellent impregnating ability to the resin film 21 for adhesion of the resin film 21 and the conductors 24, for example, varnish. Spraying the varnish to the resin film 21 may easily finish the adhesion to the conductors 24. The use of the woven fabrics 26b, 26c is intended to improve the adhesiveness as described above. It is therefore possible to have the area with no woven fabric depending on the location, that is, the woven fabrics 26b, 26c may have holes and missing parts. If the adhesiveness on both the upper and the lower surfaces of the resin film 21 is not required, the laminated film 26 used for the resin film 21 may have a two-layered structure including the film body 26a and the woven fabric 26b (or woven fabric 26c).

### <Essential Structure of Embodiment>

It is an essential point of the embodiment to use the integrally and sterically formed resin films 21a-21d for insulating the conductors 24a-24e. In other words, as described referring to FIG. 5, when ensuring insulation of two arbitrary conductors 24, 24 of the laminated structure including a plurality of conductors 24a-24e of the connector unit 20, the resin film 21, which has the uneven shape adapted to the adjacently arranged conductors 24, 24, is interposed between those conductors 24, 24. With this arrangement, it is possible to reduce the axial dimension (vertical dimension in FIG. 5) of the entire laminated structure compared with the case of achieving insulation by using generally employed insulating member (for example, resin sheet) which is not sterically formed.

The above-described effect becomes noticeable especially in the case where two of the conductors 24a-24e are arranged adjacently to each other in the radial direction. That is, the integrally formed resin film 21 with crank-like cross-section is arranged, which passes through the radial center between those two conductors from one axial side of any one of the conductors toward the other axial side of the other conductor so as to ensure insulation while preventing creeping discharge for the purpose of reducing the axial dimension. The above-described structure and the resultant effect are derived from a plurality of points of the laminated structure of FIG. 5 (for example, insulation between the conductors 24d and 24e at points A, B, C, D, E in FIG. 5). The structure of the point A and the resultant effect will be described in detail as a typical example.

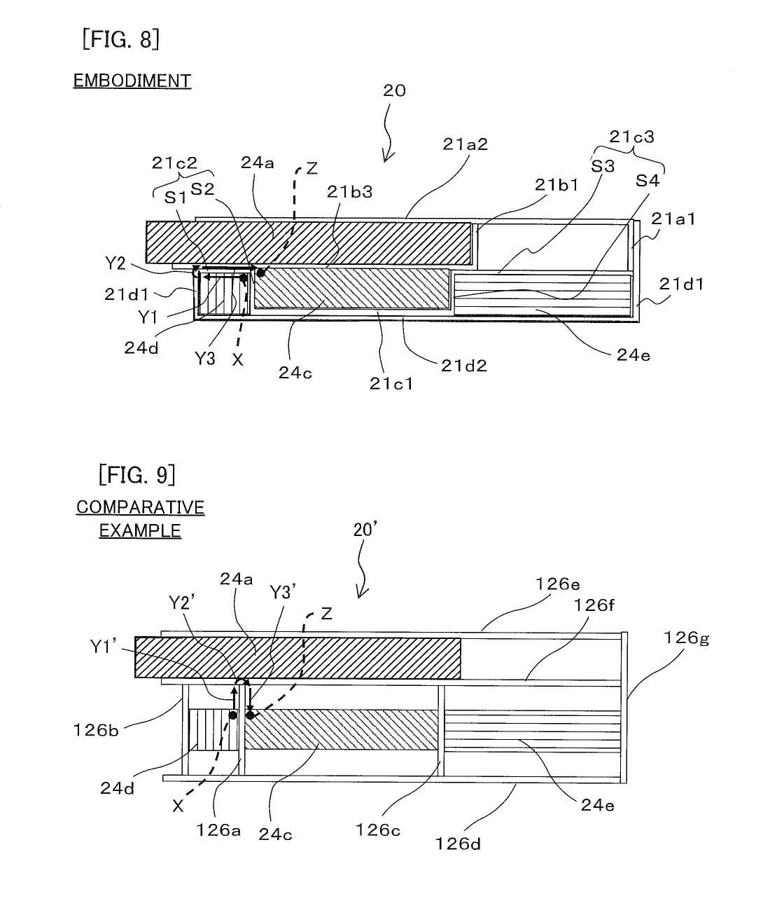

FIG. 8 is a sectional view of an axial plane W corresponding to the point A of FIG. 5 seen from the arrow R direction. As described above, at the point A, the conductor 24d is arranged at a radial outer side (left side in the drawing), and the conductor 24e is arranged at a radial inner side (right side in the drawing) of the recess region surrounded by the collars 21d1, 21d1 at both sides and the flat plate part 21d2 of the resin film 21d as the lowermost layer as shown in FIG. 8. The resin film 21c (corresponding to an example of a first resin film) is arranged so that the visors 21c2, 21c3 cover upper parts of those conductors 24d, 24e as shown in the drawing. The conductor 24c is accommodated in the recess region surrounded by the visors 21c2, 21c3 and the flat plate part 21c1 of the resin film 21c. As a result, the conductors 24d and 24c are arranged in the radial direction adjacently to each other, having the visor 21c2 (specifically, an erect part S2 to be described below) interposed therebetween. The conductors 24c and 24e are arranged in the radial direction adjacently to each other, having the visor 21c3 (specifically, an erect part S4 to be described below) interposed therebetween. The resin film 21b is arranged so that the flat plate part 21b3 covers the upper part of the conductor 24c as shown in the drawing. The conductor 24a is accommodated and arranged in the recess region defined by the flat plate part 21b3 and the collars 21b1 of the resin film 21b. The resin film 21a is arranged so that the flat plate part 21a2 further covers the upper part of the conductor 24a as shown in the drawing.

In the structure shown in FIG. 8, as described above, an illustrated part (corresponding to an example of a first arrangement part, hereinafter referred to as conductor 24d) of the conductor 24d (corresponding to an example of a first conductor) and an illustrated part (corresponding to an example of a second arrangement part, hereinafter referred to as conductor 24c) of the conductor 24c (corresponding to an example of a second conductor) are arranged adjacently to each other along the radial direction of the rotor 2. The insulation between the thus adjacently disposed conductors 24d and 24c (specifically, preventing creeping discharge) according to the embodiment will be described in reference to the comparative example.

### <Problem of Comparative Example>

FIG. 9 shows a comparative example for achieving insulation between the conductors 24d and 24c using generally employed insulating members (in the example, resin sheets 126a-126g) without using the sterically formed resin films 21 as in the embodiment shown in FIG. 8.

Referring to a connector unit 20′ of the comparative example shown in FIG. 9, the resin sheet 126 extends along the axial direction of the rotor 2 (vertical direction in FIG. 9) between the conductors 24d, 24c which are arranged adjacent to each other as described above. The creeping discharge from the conductor 24d to the conductor 24c will be discussed. For example, the path of the creeping discharge generated at the virtual starting point X at one axial side of the conductor 24d (upper side) proceeds upward in FIG. 9 along the surface of the resin sheet 126a from the virtual starting point X (refer to the arrow Y1′), and further proceeds around the axial end of the resin sheet 126 (upper end) (refer to the arrow Y2′). The path moves downward in FIG. 9 along the surface at the other side of the resin sheet 126a to reach the virtual end point Z of the conductor 24c (refer to the arrow Y3′). In order to prevent the above-described creeping discharge from the virtual starting point X to the virtual end point Z, the axial dimension of the resin sheet 126a (as well as the resin sheets 126b, 126c in the example) has to be relatively enlarged for increasing the length of the discharge path (creeping distance). In such a case, as FIG. 9 shows, a large gap is formed between the lower conductors 24d, 24c and the upper conductor 24a as shown in the drawing to enlarge the entire axial dimension of the connector unit 20′. As a result, the connector unit 20′ and the rotating electric machine 1 will be enlarged.

### Effect of the Embodiment

Referring to the structure of the embodiment shown in FIG. 8, as described above, the sterically shaped resin film 21c is interposed and arranged between the conductors 24d and 24c. Specifically, a horizontal part S1 (corresponding to an example of a first shield) which constitutes a part of the visor 21c2 radially extends at one axial side of the conductors 24 (the upper side in FIG. 8). An erect part S2 (corresponding to an example of a second shield) that constitutes a part of the visor 21c2 is interposed and axially extends between the conductors 24d and 24c which are adjacent to each other in the radial direction. The flat plate part 21c1 (corresponding to an example of a third shield) radially extends at the other axial side of the conductor 24c (the lower side in FIG. 8).

As a result, the assumable creeping discharge path from the virtual starting point X to the virtual end point Z of the above-described conductor 24d radially proceeds (refer to arrow Y1) from the virtual starting point X positioned at one axial side of the conductor 24d (that is, upward in FIG. 8, in other words, the other axial side of the horizontal part S1 or the lower side in FIG. 8) along the lower surface of the horizontal part S1, and proceeds around the radial end of the horizontal part S1 (left end in the drawing) to reach the upper side of the horizontal part S1 (refer to arrow Y2). The path further radially proceeds along the upper surface of the horizontal part S1 to reach the virtual end point Z of the conductor 24c (refer to arrow Y3). That is because the resin film 21c has integrally formed horizontal part S1 and the erect part S2 without leaving the gap therebetween. Therefore, the creeping distance from the conductor 24d to the conductor 24c may be significantly increased by the distance corresponding to the wraparound in the radial direction as described above.

Although the detailed description will be omitted, the assumable path of the creeping discharge from the conductor 24e to the conductor 24c likewise the above-described case may have the length significantly increased by the functions of the horizontal part S3 (corresponding to an example of a first shield) and the erect part S4 (corresponding to an example of a second shield) which partially constitute the visor 21c3.

At a plurality of other points such as the points B, C, D, E of the connector unit 20 likewise the above case, the resin film 21 having the horizontal part S1 (or S3) and the erect part S2 (or S4) continuously integrated is interposed and arranged between the two different conductors 24, 24 which are adjacently arranged to each other in the radial direction. As a result, likewise the case described above, the assumable discharge creeping distance between the two conductors 24, 24 may be significantly increased by the distance corresponding to the wraparound in the radial direction.

As a result, unlike the comparative example described above, the embodiment allows prevention of the creeping discharge without increasing the axial dimension of the resin film 21. Therefore, it is possible to prevent axial enlargement of the connector unit 20.

In the embodiment, especially the resin film 21 is configured to have the woven fabrics 26b and 26c applied to the respective sides of the film body 26a. With this arrangement, it is possible to improve adhesiveness between the resin film 21 and the conductor 24 by means of the adhesive and the like and to ensure rigid fixation upon production of the connector unit 20 including a plurality of conductors 24 and a plurality of resin films 21 which are axially laminated.

In the embodiment, each of the conductors 24a-24e of the connector unit 20 includes the winding connectors 22 for connection to the stator winding 4 or the cable connectors 23a-23c for connection to the power supply cable. The resin films 21a-21d include openings 27, 28 for exposing the winding connectors 22 or the cable connectors 23a-23c to the outside. As a result, it is possible to ensure reliable conduction by easily connecting the stator winding 4 or the power supply cable to the conductor 24.

In the above-described embodiments, the rotating electric machine 1 which includes the field system as the rotor 2 and the armature as the stator 3 has been explained as an example, which is not limited thereto. The rotating electric machine may be configured to include the armature as the rotor, and the field system as the stator.

Besides the above-described description, the approaches according to the embodiments may also be arbitrarily combined.

Although the explanation of any other example will be omitted, it is to be clearly understood that the present disclosure may be variously modified so long as they do not deviate from the scope of the disclosure.

What is claimed is:

1. A rotating electric machine comprising:
a rotor disposed rotatably;
a stator including a plurality of stator windings; and
a connector unit connecting ends of the plurality of stator windings, the connector unit comprising:
a plurality of conductors; and
a plurality of resin films each formed sterically to insulate the plurality of conductors from one another.

2. The rotating electric machine according to claim 1, wherein
the plurality of resin films includes at least one resin film having an uneven shape adapted to the adjacently arranged conductors.

3. The rotating electric machine according to claim 2, wherein
the at least one resin film includes at least one recess region in which the conductor is accommodated.

4. The rotating electric machine according to claim 3, wherein
the at least one resin film includes a first recess region in which the conductor is accommodated at one axial side of the resin film and a second recess region in which the conductor is accommodated at another axial side of the resin film, the first recess region and the second recess region are arranged adjacently to each other along a radial direction of the rotor.

5. The rotating electric machine according to claim 4, wherein
the plurality of conductors of the connector unit includes a first conductor and a second conductor respectively including a first arrangement part and a second arrangement part which are arranged adjacently to each other along a radial direction of the rotor, the plurality of conductors is arranged so as to be laminated along an axial direction of the rotor,
the plurality of resin films of the connector unit includes a first resin film integrally including at least a first shield extended along the radial direction at one axial side of the first arrangement part, a second shield extended along the axial direction interposed between the first arrangement part and the second arrangement part which are adjacent to each other in the radial direction, and a third shield extended along the radial direction at another axial side of the second arrangement part, each of the resin films is sterically formed in the axial direction and in the radial direction and is arranged so as to be laminated in the axial direction while being interposed between the plurality of conductors.

6. The rotating electric machine according to claim 1, wherein
the resin film of the connector unit is a three-layer structure including a woven fabric, a film body, and a woven fabric in this order from one side to the other side in a thickness direction.

7. The rotating electric machine according to claim 1, wherein
the resin film of the connector unit is formed by sterically molding a resin sheet made of a thermoplastic resin.

8. The rotating electric machine according to claim 1, wherein
the connector unit is formed by adhesively integrating the conductors and the resin films.

9. The rotating electric machine according to claim 1, wherein
each of the plurality of conductors of the connector unit includes a connector configured to connect the stator winding or a power supply cable, and
at least one of the plurality of resin films includes an opening configured to expose the connector outside without covering the connector.

10. The rotating electric machine according to claim 2, wherein
the resin film of the connector unit is a three-layer structure including a woven fabric, a film body, and a woven fabric in this order from one side to the other side in a thickness direction.

11. The rotating electric machine according to claim 3, wherein
the resin film of the connector unit is a three-layer structure including a woven fabric, a film body, and a woven fabric in this order from one side to the other side in a thickness direction.

12. The rotating electric machine according to claim 4, wherein
the resin film of the connector unit is a three-layer structure including a woven fabric, a film body, and a woven fabric in this order from one side to the other side in a thickness direction.

13. The rotating electric machine according to claim 5, wherein
the resin film of the connector unit is a three-layer structure including a woven fabric, a film body, and a woven fabric in this order from one side to the other side in a thickness direction.

14. The rotating electric machine according to claim 2, wherein
each of the plurality of conductors of the connector unit includes a connector configured to connect the stator winding or a power supply cable, and
at least one of the plurality of resin films includes an opening configured to expose the connector outside without covering the connector.

15. The rotating electric machine according to claim 3, wherein
each of the plurality of conductors of the connector unit includes a connector configured to connect the stator winding or a power supply cable, and
at least one of the plurality of resin films includes an opening configured to expose the connector outside without covering the connector.

16. The rotating electric machine according to claim 4, wherein
each of the plurality of conductors of the connector unit includes a connector configured to connect the stator winding or a power supply cable, and
at least one of the plurality of resin films includes an opening configured to expose the connector outside without covering the connector.

17. The rotating electric machine according to claim 5, wherein
each of the plurality of conductors of the connector unit includes a connector configured to connect the stator winding or a power supply cable, and
at least one of the plurality of resin films includes an opening configured to expose the connector outside without covering the connector.

18. The rotating electric machine according to claim 13, wherein
each of the plurality of conductors of the connector unit includes a connector configured to connect the stator winding or a power supply cable, and
at least one of the plurality of resin films includes an opening configured to expose the connector outside without covering the connector.

19. A rotating electric machine comprising:
a rotor disposed rotatably;
a stator including a plurality of stator windings; and
means for connecting ends of the plurality of stator windings, the means for connecting comprising:
a plurality of conductors; and
means for insulating conductors arranged adjacently to each other along a radial direction of the rotor and conductors arranged adjacently to each other along an axial direction of the rotor from one another using a resin film.
